(19) United States
(12) Patent Application Publication
(10) Pub. No.: US 2015/0314489 A1
(43) Pub. Date: Nov. 5, 2015

(54) TOOL ASSEMBLY, AND METHOD FOR MANUFACTURING A PART MADE OF A COMPOSITE MATERIAL

(71) Applicant: AIRCELLE, GONFREVILLE L'ORCHER (FR)

(72) Inventors: Guy Bernard VAUCHEL, Harfleur (FR); Eric PILLON, Benarville (FR)

(21) Appl. No.: 14/333,801

(22) Filed: Jul. 17, 2014

Related U.S. Application Data
(63) Continuation of application No. PCT/FR2013/050117, filed on Jan. 18, 2013.

(30) Foreign Application Priority Data
Jan. 18, 2012 (FR) 12/50482

(51) Int. Cl. B29C 33/50; B29C 70/30

(52) U.S. Cl. CPC B29C 33/50; B29C 70/30; B29K 2105/25

(57) ABSTRACT

A tool assembly for manufacturing a part made of a composite material having a convex surface includes a mold. The mold at least partially defines the lines of the convex surface and is shaped so as to support, in a working position, drape-molding and polymerization operations for the part. In particular, the mold has a flexible portion alternating between the working position and a removal position where the mold is retracted relative to the working position.

### CROSS-REFERENCE TO RELATED APPLICATIONS

This application is a continuation of International Application No. PCT/FR2013/050117, filed on Jan. 18, 2013, which claims the benefit of FR 12/50482, filed on Jan. 18, 2012. The disclosures of the above applications are incorporated herein by reference.

### FIELD

The present disclosure relates to tool assemblies for manufacturing a part made of a composite material by drape-molding and polymerization and to methods for implementing the tool assembly.

### BACKGROUND

The statements in this section merely provide background information related to the present disclosure and may not constitute prior art.

The manufacturing of a part made of a composite material may be carried out by a step of drape-molding plies against a male shape, that is to say, by pressing against a male shape several carbon plies, pre-impregnated or not with a resin, then by a step of polymerization, that is to say by heating the assembly in an oven in order to give the plies the required stiffness.

The constituted part is thus able to be demolded by removing the mold.

The manufacture of parts with a circumference less than 180° is relatively easy to manufacture. However, the same cannot be said for parts exhibiting geometries extending over an important angular area, in particular, more than 180°, and having lines that cannot be extracted from the mold after production of the part.

In such a case, it is thus essential to produce a mold in several portions able to be disassembled, allowing the extraction of each portion after molding.

This makes the manufacturing operation more complex, requiring additional time for assembling and disassembling the mold and results in significant additional costs for the manufacture of the mold.

An example of a particularly difficult part to produce in composite material by this type of method is an outer structure of turbojet engine nacelle such as a movable cowl of thrust reverser, for an “O-duct” type nacelle structure.

An aircraft is moved by several turbojet engines each housed in a nacelle serving to channel the air flows generated by the turbojet engine, and which can also accommodate a set of devices providing various functions such as a thrust reversal device of which the role is to improve the braking capacity of the aircraft by orienting toward the front at least part of the air of the secondary flow.

A nacelle usually exhibits a tubular structure comprising an air inlet upstream of the turbojet engine, a median section intended to surround a turbojet engine fan, a downstream section accommodating the thrust reversal means and intended to surround the combustion chamber of the turbojet engine, and is usually terminated by an ejection nozzle of which the exit is located downstream of the turbojet engine.

According to one form, it is known a nacelle intended to be supported by a pylon of the turbojet engine comprising a thrust reversal device having a unique single-piece movable cowl substantially peripheral and quasi-annular, slidably mounted on rails disposed on either side of said pylon.

Such a cowl is often called “O-duct” alluding to the shape of the shell of such a cowl, by opposition to “D-duct”, which in fact comprises two half-cowls each extending over a half circumference of the nacelle.

Hence, it is understood that the production in composite material of such an “O-duct” type cowl by unique molding is a tricky and difficult operation.

A currently used solution is to produce the shell constituting the panel by departing from the inner aerodynamic surface (outer stream) and to go up towards the outside of the nacelle before mechanically bringing back all or a portion of the outer aerodynamic structure of the component of the nacelle.

Generally, the inner aerodynamic line of the structure of the thrust reverser exhibits a convex shape making not possible the demolding of the part produced by simple extraction in one direction or the other of the molding tool. The solution for the production in composite of such a structure is to adopt a male tool in several, heavy, complex and unreliable portions.

More particularly, a key type tool is usually used. Such a tool usually comes in three, four or five portions of which the fixing together of the members is carried out inside the structure either mechanically by bolting or by a complex system of automatic connection and handling of the keys.

For the manufacture of the shell of the movable cowl of an O-duct type thrust reverser, it can be proceeded in the following manner.

First of all, the keys are assembled and sealed together. An inner skin is then drape-molded, polymerized, disassembled and pierced if required in the case of acoustic application on the shell in progress.

Cores forming the inner structure to provide inertia to the shell may be constituted for example by honeycomb or foam structures. These core members are positioned and anchored on the first skin (inner skin).

A skin intended to constitute the outer skin is over-drape-molded on the core members and the assembly is polymerized in order to constitute the first member of the movable cowl.

Independently, an outer shell resting on the outer aerodynamic lines is achieved and assembled mechanically on the inner member of the movable shell.

The drawbacks of a tool structure with keys are in particular:
the difficulty or even the impossibility to obtain a good tightness between the keys causing an increase in the time of production cycle of the part or a part to reject or to machine,
the risks of damage of the aerodynamic surface linked to the joining of the keys,
the presence of members that are bulky, expensive and heavy to handle causing a risk of damage to the members of the mold during handling tasks, significant time to consecrate to handling of the keys, as well as the necessity of a suitable workstation allowing operators to access the keys,
the necessity to recondition the keys after each polymerization with a risk of damaging the latter with each isolated handling.

Thus, there is an important need for a tool and implementing solution allowing producing such an O-Duct type structure, and more generally of any composite part extending over more than 180 degrees and/or exhibiting an inner convex structure making the demolding thereof impossible.

### SUMMARY

The present disclosure provides tool assemblies for manufacturing a part made of a composite material comprising at least one convex surface. The tool assemblies comprise at least one mold at least partially defining the lines of said convex surface and shaped to support in a working position at least a drape-molding operation and a polymerization operation of said part, said assemblies being characterized in that the mold exhibits at least one flexible portion alternately between said first working position and a second position called removal position according to which the mold is in retracted position with respect to the working position thereof.

Thus, by providing a flexible mold, it is thus possible to manufacture a part in composite material exhibiting one or several convex surfaces, by way of one single mold in one single portion, not comprising a sectorized key.

The tool assemblies according to the present disclosure allow facilitating considerably the manufacturing methods together with reducing the duration of the manufacturing cycle of such a part. The alternative passage between a working position and a removal position of the mold is provided by way of means for driving the flexible portion of the mold.

According to the present disclosure, at least the flexible portion of the mold exhibits at least one convex surface of which the ends delimit a non-closed portion.

This non-closed surface allows the existence of a deformation, thus facilitating and increasing the deformation of the flexible portion of the mold.

Advantageously, the thickness of the flexible portion of the mold is variable.

This allows achieving a constant and proportional deformation when the mold goes from a working position to a removal position.

The means for driving comprise a set of turnbuckles shaped so as to alternately provide the passage from a working position to a removal position of the mold.

In one form, the means for driving comprise a set of strappings shaped so as to alternately provide the passage from a working position to a removal position of the mold.

The tool assemblies according to the present disclosure comprise means for supporting the mold and means for centering the mold.

The mold comprises at least one additional stationary portion shaped so as to support at least one drape-molding and polymerization operation of at least one non convex surface of said part.

In another form, the mold exhibits at least one additional flexible portion shaped so as to support at least one drape-molding and polymerization operation of at least one convex surface of said part.

The flexible portion of the mold is alternately connected to said additional stationary and flexible portions via joining means comprising means for sealing and means for maintaining said portions of the mold.

The part to manufacture is a movable single-piece cowl of thrust reverser for turbojet engine nacelle.

The present disclosure also relates to methods for manufacturing a part made of composite material comprising at least one inner convex surface, said methods being characterized in that it comprises the following steps with the purpose of:
positioning the tool assembly in a position corresponding to a working position of the mold according to which said mold supports at least one drape-molding and polymerization operation;
disposing at least one ply on a convex surface of the mold;
polymerizing said plies;
positioning said tool assembly in a position corresponding to a removal position of the mold according to which said mold is in retracted position with respect to its working position; and
removing the manufactured part or said mold.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an example tool assembly according to the present disclosure;

FIG. 2 is a perspective view representing only the mold provided with the driving means;

FIG. 3 is a cross-sectional view of the mold provided with driving means, illustrating the variation in thickness of the flexible portion of the mold;

FIGS. 4 to 10 schematically illustrate an example method for manufacturing a part made of composite material exhibiting a convex surface, said part being manufactured by means of the tool assemblies according to the present disclosure;

FIG. 11 represents a second form of the tool assemblies according to the present disclosure, according to which the driving means are provided by means of a set of strappings;

FIG. 12 describes a third form of the tool assemblies according to the present disclosure according to which the mold exhibits an additional stationary portion suitable for manufacturing a composite part exhibiting a non-convex surface;

FIG. 13 represents the holding means between the stationary portion and the flexible portion of the mold according to the third form of the tool assemblies according to the present disclosure;

FIG. 14 is an enlargement of the sealing area between the stationary portion and the flexible portion of the mold;

FIG. 15 is an alternative of the holding means between the stationary and flexible portions of the mold; and

FIG. 16 represents a fourth form of the tool assemblies according to the present disclosure, according to which the mold exhibits an additional flexible portion allowing the manufacture of a composite part exhibiting at least two distinct convex surfaces.

Furthermore, on the entirety of the figures, the tool assemblies allow manufacturing the inner surface of a movable single-piece “O-Duct” cowl of a thrust reverser of turbojet engine nacelle. The term “O-Duct” designates structures for which the circumference is more than 180 degrees. However, the tool assemblies according to the present disclosure may also be used to manufacture structures less than 180 degrees circumference if those skilled in the art find it particularly useful. More generally, the tool assemblies according to the present disclosure allow realizing all parts exhibiting at least one convex shape making the demolding thereof impossible.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

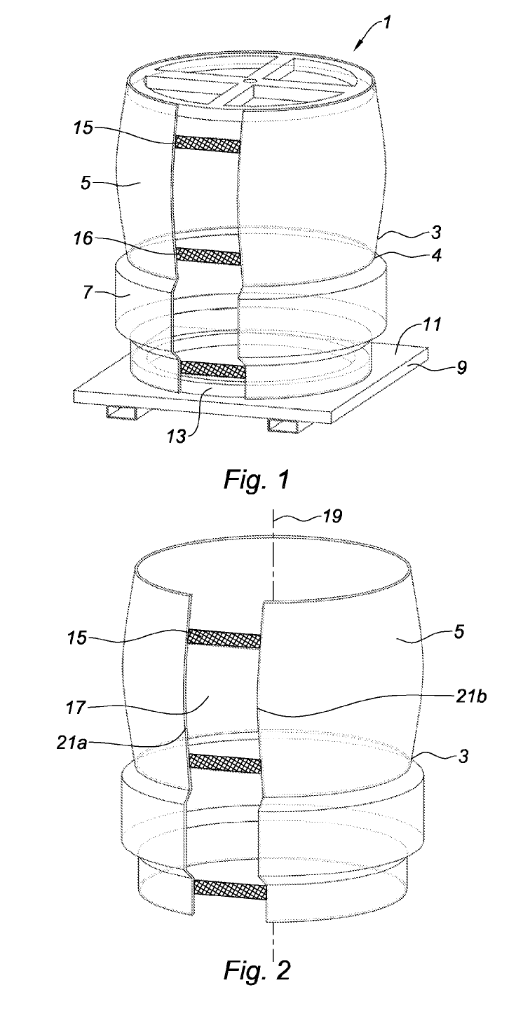

With reference to FIG. 1, illustrating the example tool assembly 1 according to the present disclosure.

The tool assembly comprises a mold 3 produced in composite material, such as epoxy carbon, thus giving the mold good elasticity and stiffness properties. Alternatively, the mold may be metallic, or in any other material known to those skilled in the art and exhibiting mechanical properties allowing combining elasticity and stiffness of the mold.

The mold 3 exhibits a flexible portion 4, comprising a convex surface 5 and a non-convex surface 7. The convex surface 5 is intended to form an acoustic area of the movable cowl of the thrust reverser (downstream area of the nacelle) and the non-convex surface 7 is intended to form the area of the movable cowl inside which will be housed the shutters allowing the reorientation of the air flow for a deployed position of the latter (upstream area of the nacelle). To this end, the convex and non-convex surfaces of the mold define the lines of the surface of the part to be manufactured.

The mold 3 is supported in vertical position by supporting means constituted by a base 9 in the shape of a plane plate 11 in lower portion of which are positioned two brackets on the ground of said plate. The mold is maintained in position on said plate by way of means for centering the mold constituted by a guide pin 13 secured to the plate 11. According to an alternative not represented on the figures, it can be considered to position the mold in horizontal position by way of a support of the mold suited to this orientation and allowing the clearing of the part from the opposite side of the support of the mold.

The tool assembly 1 comprises driving means 15 of the mold 3. These means are able to be mechanically or hydraulically activated via a non-represented device, or even manually, or by any other driving system known by those skilled in the art.

As is described in further detail hereinafter, activating the driving means 15 will allow making the circumference of the mold vary.

The driving means 15 are constituted by turnbuckles 16 positioned inside the mold 3.

However, the driving means may be constituted by any other manual or automated system known by those skilled in the art, such as for example a set of electric, hydraulic or pneumatic jacks.

Reference is now made to FIG. 2, illustrating the mold 3 provided with driving means 15.

The mold 3 exhibits on its convex surface 5 a non-closed portion 17 in a direction substantially parallel with an axis of revolution 19 of the mold.

The mold 3 is thus not closed, thus defining a degree of deformity of the mold.

The non-closed portion allows the mold 3 to adopt variable circumferences controlled by the driving means 15. In fact, during the activation of the activating means, the ends 21a and 21b tend to become mutually closer together, thus allowing reducing the circumference of the mold 3 and thus lead to the tightening thereof in order to remove the mold from the manufactured part.

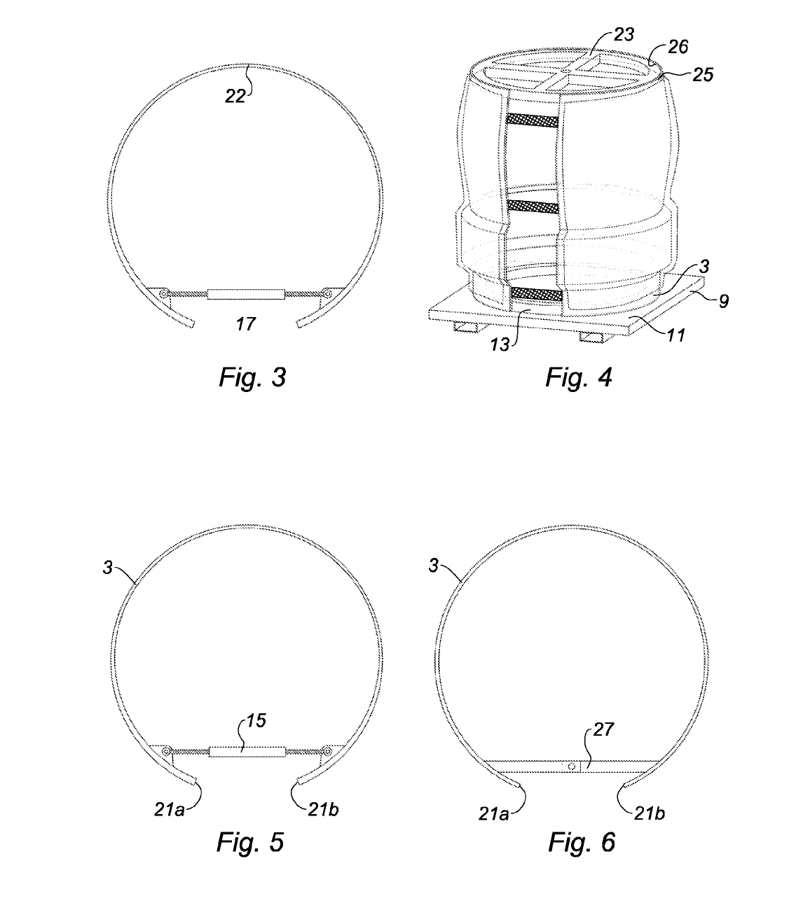

To this end, the mold advantageously adopts a variable thickness in order to provide a constant deformation. As represented on FIG. 3, illustrating a transversal section of the mold, the flexible portion of the mold exhibits an area of reduced thickness on the portion 22 opposite to the non-closed portion 17, thus allowing keeping a circular section of the mold, when the latter switches from a working position to a removal position.

According to one form, it is provided that a longitudinal section of the flexible wall of the mold exhibits a non-constant thickness.

The example method for manufacturing a part made of composite material of convex shape is described hereinafter, with reference to FIGS. 4 to 10.

Referring to FIG. 4, the mold 3 is supported by the base 9 and maintained in position by means for centering the mold. Such centering means comprise a guide pin 13 secured to the plate 11 of the base, and a guide pin 23 positioned in the vicinity of the upper end 25 of the mold 3.

Such guide pins advantageously adopt a circular shape of which the diameter substantially corresponds to that of the part to be manufactured, and bear on the inner surface 26 of the mold 3. However, such guide pins may exhibit a shape other than the aforementioned circular shape if those skilled in the art find it particularly useful.

The guide pins 13, 23 advantageously allow providing a peripheral bracket to the mold and providing a precise shaping of the mold. The mold 3 is thus in a position referred to as a working position, a position which is now shaped for manufacturing a part made of composite material by drape-molding several plies and by polymerizing said plies.

In another form, it is provided to dispose intermediate guide pins, that is to say, guide pins positioned in parallel with the guide pins 13 and 23, but at an altitude that is different from that of guide pins 13, 23. These additional intermediate guide pins are particularly interesting for increasing the precision of adjusting and holding in position of the mold during steps of drape-molding and polymerization of the plies.

These guide pins may be associated together by the center to be for example used in a horizontal position for a better integration in the curing oven of the part.

The drape-molding step includes pushing on the surface of the mold several plies made of carbon pre-impregnated with a resin. Several plies are stacked against the convex and non-convex surfaces of the mold, thus forming successive layers, and maintained pressed against the outer surfaces of the mold by means of a vacuum bladder. Then, in order to provide a cohesion to the layers until then maintained on the mold, the plies are polymerized. Usually, this operation consists in placing in a curing oven the tool assembly on which have been positioned the plies of fabric, in order to heat said plies to give the part the required mechanical resistance.

The tool assembly may allow producing additional steps to the steps of drape-molding and polymerization, such as for example the placing of nida layers prior to the steps of drape-molding and polymerization of the assembly.

The working position which has just been described is illustrated in top view in FIGS. 5 and 6, the guide pins and the base not being represented for better visibility.

The spacing between the ends 21a and 21b of the mold 3 is adjusted by way of driving means 15, which are in stretched position for a working position of the mold 3.

According to another form represented in FIG. 6, it is provided to equip the tool assembly 1 with position maintaining means 27. These means may be constituted by manual or automatic indexing and alignment and allow maintaining the required spacing between the ends 21a and 21b of the mold 3.

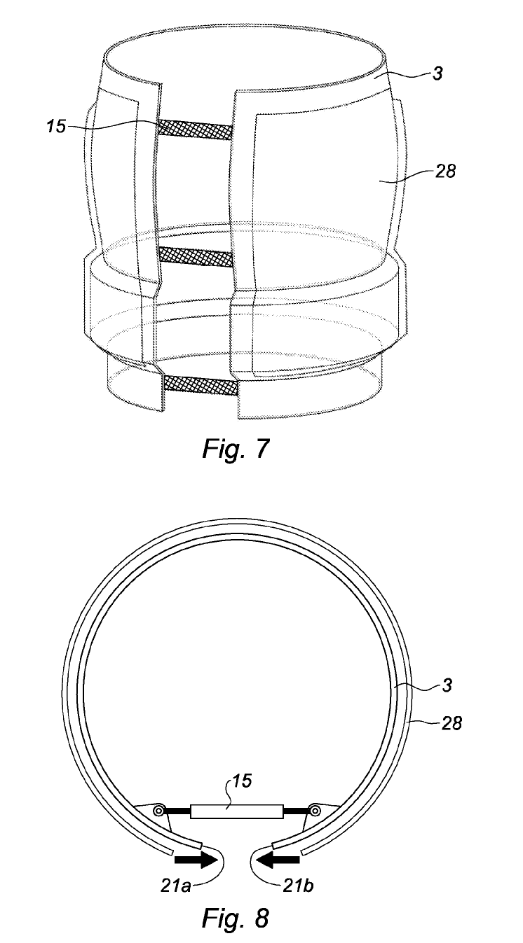

Reference is made to FIG. 7. When the user has finished the steps allowing the manufacture of the part in composite material 28, the user disassembles the base and the guide pins from the tool assembly. The mold 3 is thus able to be tightened by way of the driving means 15.

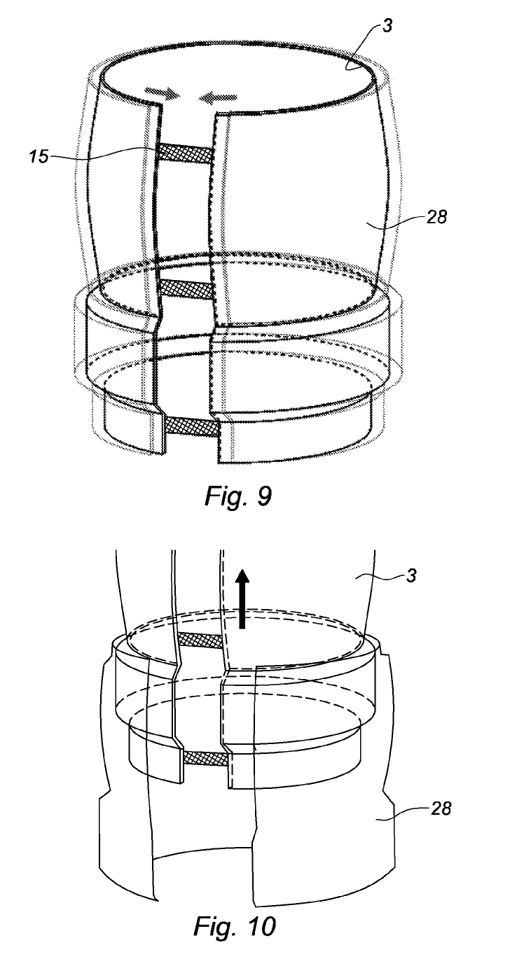

Reference is made to FIGS. 8 and 9 illustrating the tightening step of the mold.

The user activates the means 15 for driving the mold, thus leading to mutually bringing closer together the ends 21a and 21b of the mold 3. Thus, the mold switches from the aforementioned working position to a removal position of the mold, a position according to which the driving means are retracted with respect to their previous stretched position.

The mold 3 thus does not support the manufactured part 28 any longer, as is visible on FIGS. 8 and 9.

The user now proceeds with the step of removing the mold, corresponding to a removal of the mold 3 from the manufactured part 28, as represented on FIG. 10. Alternatively, the user may also remove the manufactured part from the mold.

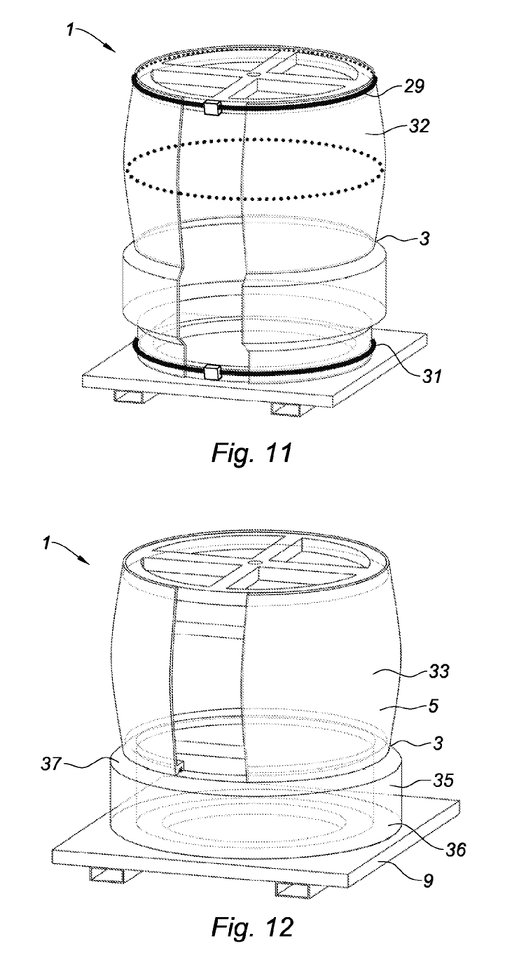

Reference is now made to FIG. 11, illustrating a second form of the mold driving means.

According to this form, the tool assembly 1 is identical with the previous form with the exception that the driving means comprise an upper strapping 29 and a lower strapping 31.

Usually, these strappings are positioned on the external wall 32 of the mold 3, outside the areas of the mold intended for the drape-molding of the plies of fabric and the placing of the vacuum bladder.

These strappings are maintained at the external wall of the mold by means of positioners suited to or brought onto the mold or the guide pin 23.

These strappings have the advantage of replacing at least the extreme turnbuckles 15, thus, allowing lightening the structure of the mold in weight and in number of components.

Reference is now made to FIG. 12, illustrating a third form of the tool assemblies according to the present disclosure.

According to this form, the mold 3 is produced in two independent portions. The mold 3 exhibits a flexible portion 33 comprising a convex surface 5 in accordance with the aforementioned description made for the two previous forms and a non-deformable stationary portion 35.

The tool assembly comprises means for driving the flexible portion of the mold and the guide pins positioned in the vicinity of the lower and upper ends of the mold.

The flexible portion may also comprise a non-convex surface if those skilled in the art find it particularly useful.

The stationary portion 35 adopts the shape of a cylinder, and allows manufacturing by drape-molding and polymerization a portion of the part to be manufactured which does not exhibit a convex surface which would prevent the demolding without tapering of the circumference of the mold.

The lower end 36 of the stationary portion 35 rests on the base 9 of the tool assembly 1. At its upper end 37, the stationary portion of the mold supports the flexible portion 33 of said mold.

In still another form, the stationary portion of the mold may rest on the flexible portion.

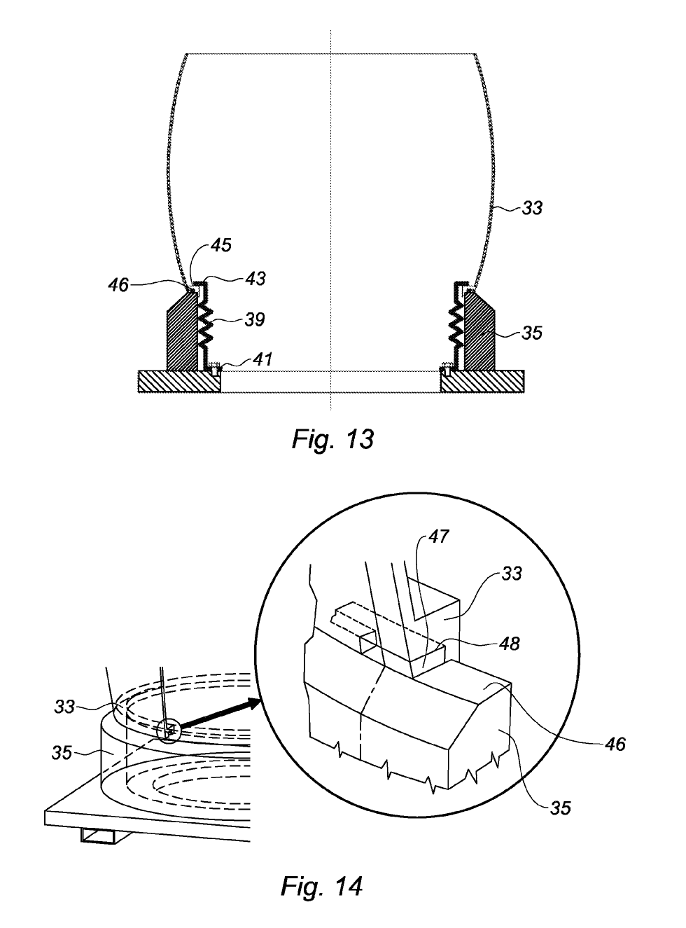

FIG. 13 illustrates an example of maintaining the flexible portion 33 on the stationary portion 35 of the mold.

The maintaining between the two portions of the mold is achieved thanks to a single-piece or sectorized elastic maintaining system 39, of which an end 41 is fixed to the base 9 by screwing, and of which the other end 43, pressed against a plane surface 45 of the flexible portion 33, itself bears against a plane surface 46 of the stationary portion 35, providing pressure. Such an elastic maintaining system allows creating a constant peripheral force providing pressure providing the maintaining of the flexible mold on the stationary mold.

In one form, this interface may be directly screwed or pinched without an elastic artifice according to the access time for the implementation of the required mold.

The sealing according to the first form is provided via a seal 47 visible in FIG. 14. The seal is positioned on the plane surface 46 of the stationary portion 35 and is inserted into a circumferential groove 48 of the flexible portion 33.

In order to increase the sealing between the stationary and flexible portions of the mold, the seal 47 may exhibit a seal return on the outer portion, this seal return providing the continuity of the sealing of the vacuum bladder.

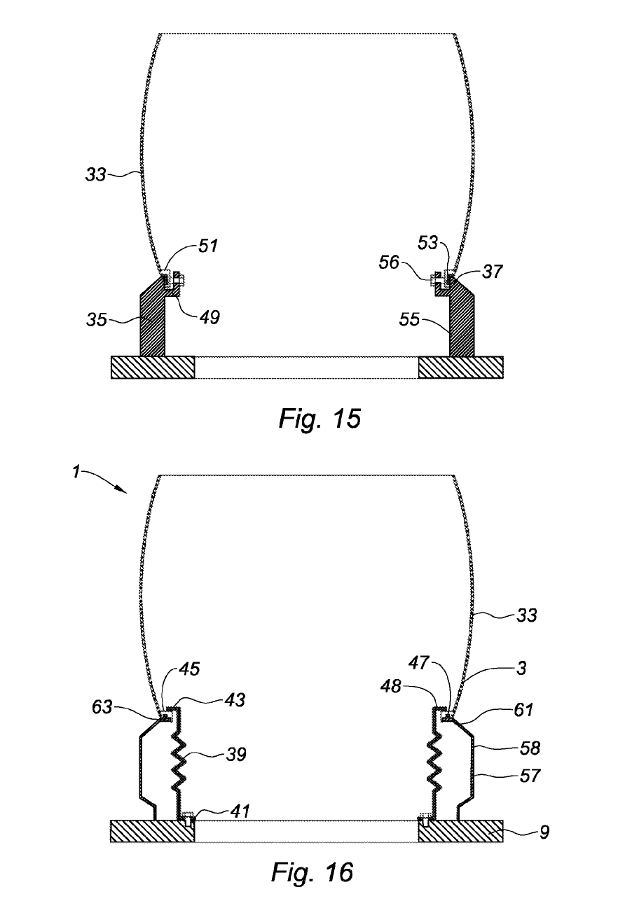

According to another form represented in FIG. 15, the interface between the stationary and flexible portions of the mold is no longer plane but circumferential, that is to say, that the stationary portion 35 comprises at its upper end 37 a circumferential groove 49 shaped to receive a male portion 51 of the flexible portion 33 of the mold. The fixing between the two portions of the mold is then achieved by pressing the flexible portion 33 onto the stationary portion 35.

The sealing is achieved according to this second form thanks to a seal 53 of which the section exhibits an inverted L shape, bearing against an inner surface 55 of the stationary portion 35. A screw 56 presses on the flexible structure 33 so that the seal is pressed against the inner surface 55 of the stationary portion 35.

According to these two described configurations providing the sealing of the mold, the seal 47, 53 is preferably achieved in silicon, which allows resisting to the polymerization temperature during the step of polymerization of the plies. The seal 47, 53 may be achieved in any other material exhibiting good sealing and heat resistance properties.

According to this third form, the flexible portion of the mold is reduced with respect to the first two forms, thus allowing facilitating the handling of the mold and to have less weight to move. Furthermore, the open portion of the flexible portion of the mold being reduced, the number of mold driving means will also be limited with respect to the first two forms.

Reference will be now made to FIG. 16, illustrating a fourth form of the present disclosure.

According to this configuration of the example tool assembly according to the present disclosure, the mold comprises two superposed flexible portions 33, 57.

The flexible portion 57 exhibits a convex surface 58 and allows manufacturing by drape-molding and polymerization a portion of the part to manufacture which exhibits a convex surface distinct from the convex surface able to be produced by the flexible portion 33.

The flexible portion 57 may of course also comprise a non convex surface if those skilled in the art find it particularly useful.

The flexible portion 57 comprises driving means similar to those aforementioned with reference to the flexible portion 33.

The lower end 59 of the flexible portion 57 rests on the base 9 of the tool assembly 1. At its upper end 61, the flexible portion 57 supports the flexible portion 33 of the mold 3.

The maintaining of the two portions of the mold is achieved thanks to the aforementioned pressure system 39, of which the end 41 is fixed to the base 9 by screwing, and of which the other end 43 presses on the plane surface 45 of the flexible portion 33, itself bearing against the plane surface 63 of the flexible portion 57.

The sealing between the two portions of the mold 3 is provided via a seal 47 in accordance with the description made for the third form of the assembly, when the mold comprised a flexible portion and a stationary portion. The seal 47 is positioned on the plane surface 63 of the flexible portion 57 and is inserted in the circumferential groove 48 of the flexible portion 33.

According to this fourth form, the flexible portion 57 allows producing a part made of composite material which exhibits at least two distinct convex surfaces.

The manufacturing methods of the present disclosure allow manufacturing a part made of composite material exhibiting a convex surface.

This methods are considerably simplified with respect to the prior art thanks to the tool assemblies according to the present disclosure. In fact, said assemblies allow manufacturing a composite part exhibiting at least one convex surface, without requiring the use of several tool assemblies.

The present disclosure thus allows reducing the number of molds required for the manufacture of parts exhibiting convex surfaces, which, on the one hand, reduces the weight of the tool and on the other hand considerably facilitates the manufacturing method and further reduces the duration of the manufacturing cycle of such a part. Furthermore, the manufacturing cost of the tool is as a result also reduced.

What is claimed is:

1. A tool assembly for manufacturing a part made of a composite material which comprises at least one convex surface, the tool comprising:
at least one mold defining at least partially lines of the convex surface, the mold being shaped to support in a working position at least a drape-molding operation and a polymerization operation of the part,
wherein the at least one mold comprises at least one flexible portion alternately between the first working position and a second position called removal position where the mold is in a retracted position with respect to the working position thereof.

2. The tool assembly according to claim 1, wherein an alternative passage between the working position and the removal position of the at least one mold is provided by means for driving the at least one flexible portion of the mold.

3. The tool assembly according to claim 2, wherein the means for driving comprises a set of turnbuckles shaped so as to provide the alternative passage between the working position and the removal position of the at least one mold.

4. The tool assembly according to claim 2, wherein the means for driving comprise a set of strappings shaped so as to provide the alternative passage between the working position and the removal position of the at least on mold.

5. The tool assembly according to claim 1, wherein the at least one flexible portion of the at least one mold comprises at least one convex surface of which ends delimit a non-closed portion.

6. The tool assembly according to claim 5, wherein the flexible portion of the at least one mold is alternately connected to additional stationary and flexible portions via joining means, which support at least one drape-molding and polymerization operation of at least one non-convex surface and at least one convex surface of the part, respectively, wherein the joining means comprise means for sealing and means for maintaining the additional stationary and flexible portions of the mold.

7. The tool assembly according to claim 1, wherein a thickness of the at least one flexible portion of the at least one mold is variable.

8. The tool assembly according to claim 1, further comprising means for supporting the at least one mold and means for centering the mold.

9. The tool assembly according to claim 1, wherein the at least one mold comprises at least one additional stationary portion shaped so as to support at least one drape-molding and polymerization operation of at least one non-convex surface of the part.

10. The tool assembly according to claim 1, wherein the at least one mold comprises at least one additional flexible portion shaped so as to support at least one drape-molding and polymerization operation of the at least one convex surface of the part.

11. The tool assembly according to claim 1, wherein the part to manufacture is a movable single-piece cowl of a thrust reverser for a turbojet engine nacelle.

12. A method for manufacturing a part made of composite material comprising at least one inner convex surface, the method comprising:
positioning the tool assembly according to claim 1 in a position corresponding to the working position of the at least one mold;
disposing at least one ply on the convex surface of the at least one mold;
polymerizing the at least one ply;
positioning the tool assembly in a position corresponding to the removal position of the at least one mold; and
removing the part or the at least one mold.
